(19) United States
(12) Patent Application Publication
(10) Pub. No.: US 2004/0095677 A1
(43) Pub. Date: May 20, 2004

(54) Method of mounting two planar objects so that they are relatively rotatable, and disk cartridge constructed according to the method

(75) Inventor: Fumihito Imai, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/704,903

(22) Filed: Nov. 12, 2003

(30) Foreign Application Priority Data
Nov. 15, 2002 (JP) 332121/2002

(51) Int. Cl. G11B 23/03

(52) U.S. Cl. 360/133

(57) ABSTRACT

A method for mounting two planar objects so that they are relatively rotatable, in which a welding step and a pressing step are eliminated, is provided. At least three slits are formed in a first planar object, extending radially from the center point of relative rotation at equal angular intervals. The first planar object is made to approach a second planar object, in a manner such that the center point moves along the axial line of a cylinder provided on the second planar object. Thereby, the cylinder is press fit into a region of the first planar object which includes the slits. The region is spread, and the edges thereof are fitted rotatably about the outer peripheral surface of the cylinder.

### BACKGROUND OF THE INVENTION

1. Field of the Invention

The present invention relates to a method of mounting two planar objects so that they are relatively rotatable. Particularly, the present invention relates to a mounting method which is applicable to an axial support structure of a rotary shutter, in a disk cartridge equipped with a rotary shutter. The present invention also relates to a disk cartridge in which a rotary shutter has been mounted on a metal shell according to the mounting method.

2. Description of the Related Art

Conventionally, recording media such as a miniature magnetic disk cartridge called “clik! ®”, as described in U.S. Pat. No. 6,256,168, are used in mobile equipment such as digital cameras. FIG. 6A is a plan view, FIG. 6B is a bottom view, and FIG. 7 is a sectional view taken along the line VII-VII of FIG. 6B showing this type of magnetic disk cartridge 1. The magnetic disk cartridge 1 comprises: a housing formed of a resin frame 2 having a pressing portion 2a, a metallic upper shell 3, a metallic lower shell 4; and a magnetic disk 5 rotatably housed in the housing. The housing has a width of 50 mm, a depth of 55 mm, and a thickness of 1.95 mm. The magnetic disk 5 has a diameter of 1.8 inches (45.7 mm), and has a recording capacity of 40 MB. A center core 10, provided with a central aperture 10a, is fixedly attached to the center of the magnetic disk 5.

The magnetic disk cartridge 1 is structured to be loaded into a slot of a Type II PC card type drive apparatus (not shown). The Type II PC card type drive apparatus has a width of 53 mm, a depth of 85 mm, and a thickness of 5 mm. V-shaped openings 6, for allowing a magnetic head provided in the drive apparatus to access the surfaces of the magnetic disk 5, are formed in the upper and lower shells 3 and 4. A rotary shutter 7 provided with an opening 7a, for rotatably opening and closing the openings 6, is provided inside the upper and lower shells 3 and 4. The rotary shutter 7 is urged toward a closing direction by a spring member (not shown).

The rotary shutter 7 comprises upper and lower shutter members 7U and 7L. The shutter members 7U and 7L are engaged to each other. As shown in FIG. 7, the upper shutter member 7U is axially supported by a small diameter cylinder 3a, which is formed by a burring process administered to the upper shell 3. An extraction prevention member 11 called a center pin, for preventing extraction of the upper shutter member 7U from the cylinder 3a, is fixed to the tip of the cylinder 3a by welding.

A large diameter opening 4a for allowing the center core 10 to face the exterior is formed at the center of the lower shell 4. A downwardly extending large diameter cylinder 7La, which is formed by a burring process administered to the lower shutter member 7L, floatingly engages the circumferential edge of the opening 4a. The cylinder 7La axially supports the lower shutter member 7L so that it is rotatable with respect to the lower shell 4. A flange 12 is formed at the tip of the cylinder 7La to prevent extraction of the lower shutter member 7L from the lower shell 4.

An arcuate groove 4b, which is concentric with the rotary shutter 7, is formed in the lower shell 4. As shown in FIG. 6b, a shutter knob 7b, which protrudes from the arcuate groove 4b and moves along the arcuate groove 4b to open and close the rotary shutter, is provided on the lower shutter member 7L. Accompanying a loading operation of the magnetic disk cartridge 1 into a drive apparatus, an engagement wall of the drive apparatus engages the shutter knob 7b. The rotary shutter 7 is caused to rotate approximately 60 degrees, to a position at which the opening 7a is aligned with the openings 6 of the upper and lower shells 3 and 4. This construction exposes the magnetic disk 5 through the openings 6 of the upper and lower shells 3 and 4.

Liners 13, which serve as cleaning members for the magnetic disk 5, are adhesively attached to the interior surfaces of the upper shutter member 7U and the lower shutter member 7L, which face the magnetic disk 5.

As described above, in the conventional magnetic disk cartridge 1, the upper shutter member 7U is rotatably mounted on the upper shell 3 in the following manner. First, the cylinder 3a, which is erected on the lower surface of the upper shell 3 by a burring process, is inserted through an axial aperture of the upper shutter member 7U. Then, the extraction prevention member 11 called the center pin is fixed to the tip of the cylinder 3a by welding.

Likewise in the conventional magnetic disk cartridge 1, the lower shutter member 7L is rotatably mounted on the lower shell 3 in the following manner. The downwardly extending large diameter cylinder 7La is erected at the center of the lower shutter member 7L. The cylinder 7La is inserted through the circular opening 4a of the lower shell 4. Then, the tip of the cylinder 7La is pressed to form a flange 12, which prevents extraction of the lower shutter member 7L from the lower shell 4.

Further, although not shown in the figures, a shutter locking member for locking the rotary shutter 7 in the closed position is axially supported by a cylinder formed by burring the upper shell 3. A flange for preventing extraction of the shutter locking member is formed at the tip of this cylinder as well.

These mounting methods require costly welding apparatuses and press machines for forming the flanges. In addition, sputter dust is generated during welding of the extraction prevention member 11. The fine sputter dust attaches to the surface of the magnetic disk 5, and causes problems in the reading and writing of data thereto. Further, the sputter dust causes another problem, that of contaminating the work environment at the assembly location.

### SUMMARY OF THE INVENTION

The present invention has been developed in view of the circumstances described above. It is an object of the present invention to provide a method of mounting two planar objects so that they are relatively rotatable, without a welding step or a pressing step. It is another object of the present invention to provide a disk cartridge in which a rotary shutter is mounted onto a metal shell according to the mounting method.

The method of the present invention is a method of mounting a first planar object to a cylinder perpendicularly erected on a second planar object so that the two planar objects are relatively rotatable with respect to each other while maintaining a substantially parallel relationship, comprising the steps of:

forming at least three slits, which extend radially from the center of relative rotation at substantially equal angular intervals, in the first planar object;

making the first and second planar objects approach each other in a manner that the center of relative rotation of the first planar object moves along the axis of the cylinder of the second planar object, while maintaining a substantially parallel relationship therebetween;

press fitting the cylinder into the region of the first planar object having the slits formed therein, causing the region to spread, and thereby rotatably fitting the edges of the region about the outer peripheral surface of the cylinder.

In this case, it is preferable that a guide aperture, which has a smaller diameter than the outer diameter of the cylinder and which has as its center the center of relative rotation, is formed in the first planar object; and

the slits are formed to extend outwardly from the outer edge of the guide aperture.

The cylinder may be formed by a burring processes administered to the second planar object.

It is preferable that a groove, for the edges of the region to engage, is formed in the outer peripheral surface of the cylinder, surrounding the outer peripheral surface of the cylinder.

The disk cartridge of the present invention comprises a flat housing formed by a metal shell;

a disk, which serves as a recording medium, rotatably housed within the housing;

an opening, for allowing a recording/reproducing head provided in a drive apparatus to access the surface of the disk, provided in the housing; and

a rotary shutter, for opening and closing the opening, axially supported to be rotatable by a cylinder, which serves as a shaft, formed on the metal shell; wherein

a guide aperture, which has a smaller diameter than the outer diameter of the cylinder and which has as its center the center of relative rotation of the rotary shutter, in the rotary shutter;

at least three outwardly extending slits are formed at substantially equal angular intervals in the outer edge of the guide aperture; and

the cylinder is press fit into the region which includes the slits so that the rotary shutter is axially supported to be rotatable by the cylinder by the edges of the region elastically contacting the outer peripheral surface of the cylinder.

According to the method of the present invention, the cylinder is press fit into the region in which the slits are formed. Thereby, the edges of the region elastically contact the outer peripheral surface of the cylinder while forming acute angles in the direction of extraction. Therefore, the two planar objects are capable of being mounted so that they are relatively rotatable, without providing an extraction prevention means. Accordingly, a welding step for an extraction prevention member and a pressing step for an extraction prevention flange are eliminated, and the necessity of a costly welding apparatus and a press machine are obviated. In addition, problems associated with welding, such as adverse influence on reading and writing operations with respect to the recording medium and contamination of the work environment, caused by sputter dust, are avoided.

By forming a guide aperture having a smaller diameter than the cylinder and which has as its center the center of relative rotation, in the first planar object, the assembly precision is improved. In addition, the contact area of the edges with respect to the outer peripheral surface of the cylinder is increased, thereby realizing a stable axial support structure.

Further, by forming a groove, for the edges of the region to engage, in the outer peripheral surface of the cylinder, surrounding the outer peripheral surface of the cylinder, positioning of a sliding contact portion is facilitated.

The smaller the number of slits, the easier the planar object is to process. However, a small number of slits causes a problem that the region between the edges becomes difficult to deform during press fitting of the cylinder. If the number of slits is large, the planar object becomes difficult to process. However, in this case, the region between the edges becomes easy to deform during press fitting of the cylinder.

### BRIEF DESCRIPTION OF THE DRAWINGS

FIG. 1 is a magnified sectional view of an axial support structure of a rotary shutter of a magnetic disk cartridge to which the mounting method of the present invention has been applied.

FIG. 2 is a plan view of an upper shutter member having a guide aperture and slits formed at its rotational center, to implement the mounting method of the present invention.

FIG. 3A, FIG. 3B and FIG. 3C are diagrams for explaining the mounting method of the present invention.

FIG. 4A and FIG. 4B are sectional views illustrating an alternate axial support structure according to the mounting method of the present invention.

FIG. 5A and FIG. 5B are plan views showing manners in which slits are formed.

FIG. 6A is a plan view of a conventional magnetic disk cartridge.

FIG. 6B is a bottom view of a conventional magnetic disk cartridge.

FIG. 7 is a magnified sectional view of an axial support structure of a rotary shutter of the magnetic disk cartridge of FIG. 6A and FIG. 6B.

### DESCRIPTION OF THE PREFERRED EMBODIMENTS

Hereinafter, preferred embodiments of the present invention will be described in detail with reference to the attached drawings.

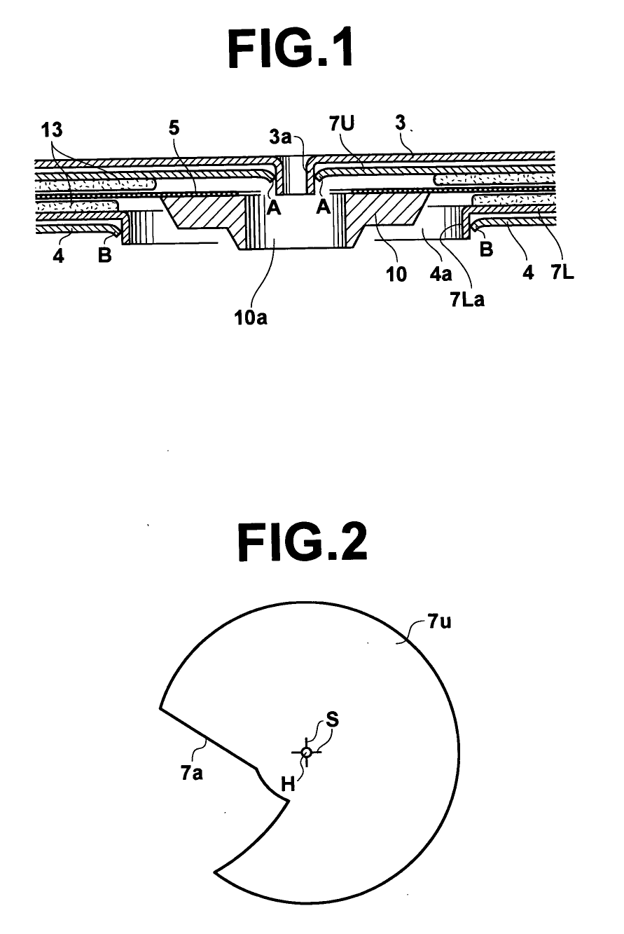

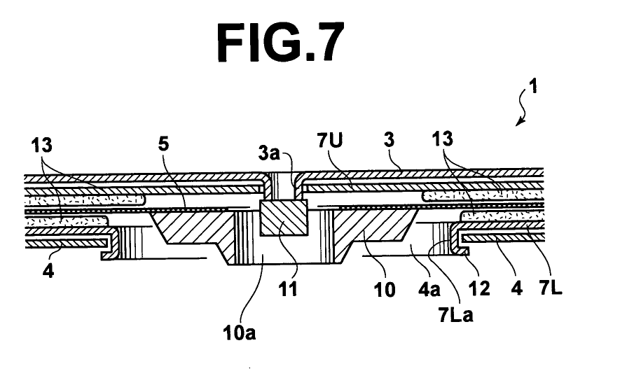

FIG. 1 is a magnified sectional view of an axial support structure of a magnetic disk cartridge to which the mounting method of the present invention has been applied, corresponding to the magnified sectional view of a conventional disk cartridge shown in FIG. 7.

In FIG. 1, the structures other than the axial support structure of the rotary shutter are the same as that of the conventional magnetic disk cartridge 1 shown in FIG. 7. Corresponding parts are denoted with the same reference numerals, and redundant descriptions will be omitted. In the present embodiment, the extraction prevention member 11 shown in FIG. 7 has been removed. Instead, the upper shutter member 7U is mounted to the upper shell 3 in the following manner. Edges of a downwardly curving region A of the upper shutter member 7U are rotatably fitted about the outer peripheral surface of the cylinder 3a, which has been formed by burring on the lower surface of the upper shell 3.

In addition, the extraction prevention flange 12 shown in FIG. 7 is not provided on the cylinder 7La formed on the lower shutter member 7L. Instead, the lower shutter member 7L is mounted to the lower shell 4 in the following manner. Edges of a downwardly curving region B of the lower shell 4 are rotatably fitted about the outer peripheral surface of the cylinder 7La.

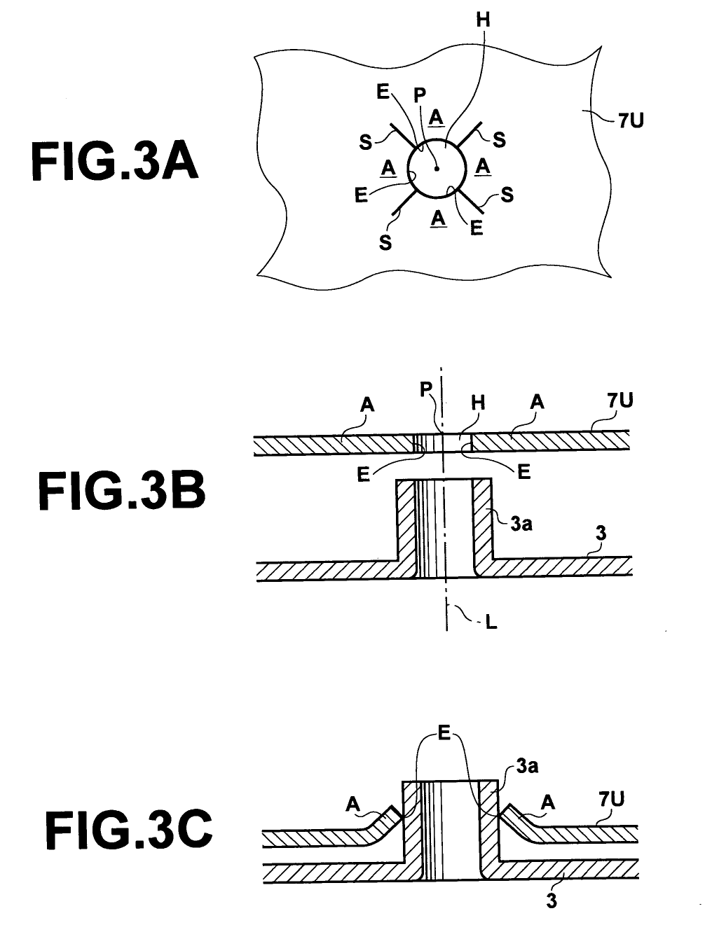

Next, the case of mounting the upper shutter member 7U (first planar object) to the upper shell 3 (second planar object) according to the mounting method of the present invention will be described with reference to FIG. 2, FIG. 3A, FIG. 3B, and FIG. 3C. Note that the upper shutter member 7U and the upper shell 3 may be formed either from metal or resin. However, from the viewpoint of strength, it is preferable that the upper shutter member 7U be formed from an aluminum alloy plate having a thickness of 0.15 mm, and that the upper shell is formed from a stainless steel plate having a thickness of 0.2 mm.

First, as shown in FIG. 2 and FIG. 3A, a guide aperture H having a smaller diameter than the cylinder 3a of the upper shell 3, and which has as its center the center of rotation P of the upper shutter member 7U, is formed in the upper shutter member 7U. Then, four slits S, which extend radially outward from the edge of the guide aperture H with the center P as their center, are formed, maintaining equal angular intervals of approximately 90 degrees therebetween.

Next, as shown in FIG. 3B, the upper shell 3 is placed so that the cylinder 3a is erect, the upper shutter member 7U is placed above the upper shell 3 to be parallel therewith, and the center point P of the upper shutter member 7U is aligned with an axial line L of the cylinder 3a.

Thereafter, the upper shutter member 7U and the upper shell 3 are made to approach each other in a manner that the center point P moves along the axial line L of the cylinder 3a. Thereby, the cylinder 3a is press fit into the region A, which includes the four slits S, of the upper shutter member 7U, and edges E among the slits S are rotatably fitted about the outer peripheral surface of the cylinder 3a, as shown in FIG. 3C. In this manner, the upper shutter member 7U and the upper shell 3 are mounted so that they are relatively rotatable, while maintaining a substantially parallel relationship.

As is clear from the description above, according to the present embodiment, the cylinder 3a is press fit into the region A, in which the slits S are formed, of the upper shutter member 7U. Thereby, the edges E of the region A elastically contact the outer peripheral surface of the cylinder while forming acute angles in the direction of extraction. Therefore, the upper shutter member 7U and the upper shell 3 are capable of being mounted so that they are relatively rotatable, without providing an extraction prevention means. Accordingly, a welding step for an extraction prevention member and a pressing step for an extraction prevention flange are eliminated, and the necessity of a costly welding apparatus and a press machine are obviated. In addition, problems associated with welding, such as adverse influence on reading and writing of data from and to the recording medium and contamination of the work environment, caused by sputter dust, are avoided.

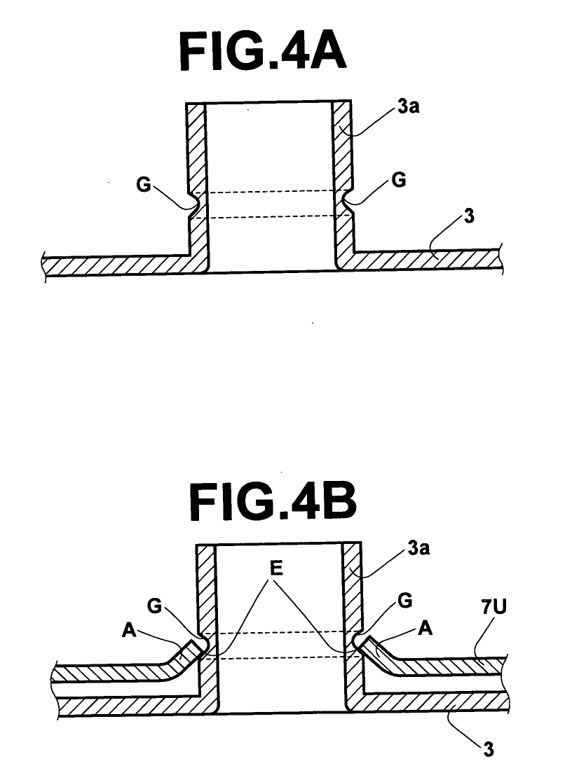

Note that as shown in FIG. 4A and FIG. 4B, a groove G surrounding the outer peripheral surface of the cylinder 3a may be formed in the outer peripheral surface of the cylinder 3a. The edges E among the slits S in the region A may be engaged within the groove G. This is a more preferable construction, because positioning of a sliding portion is facilitated.

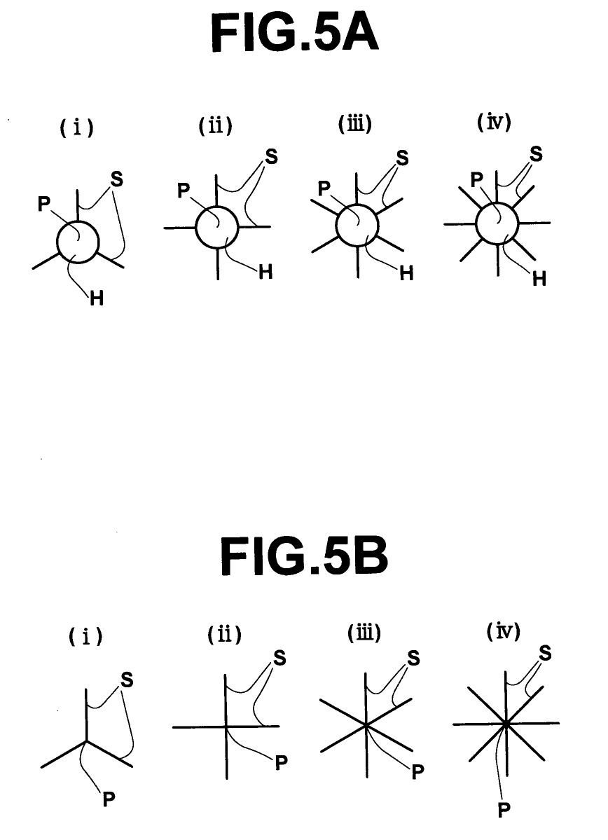

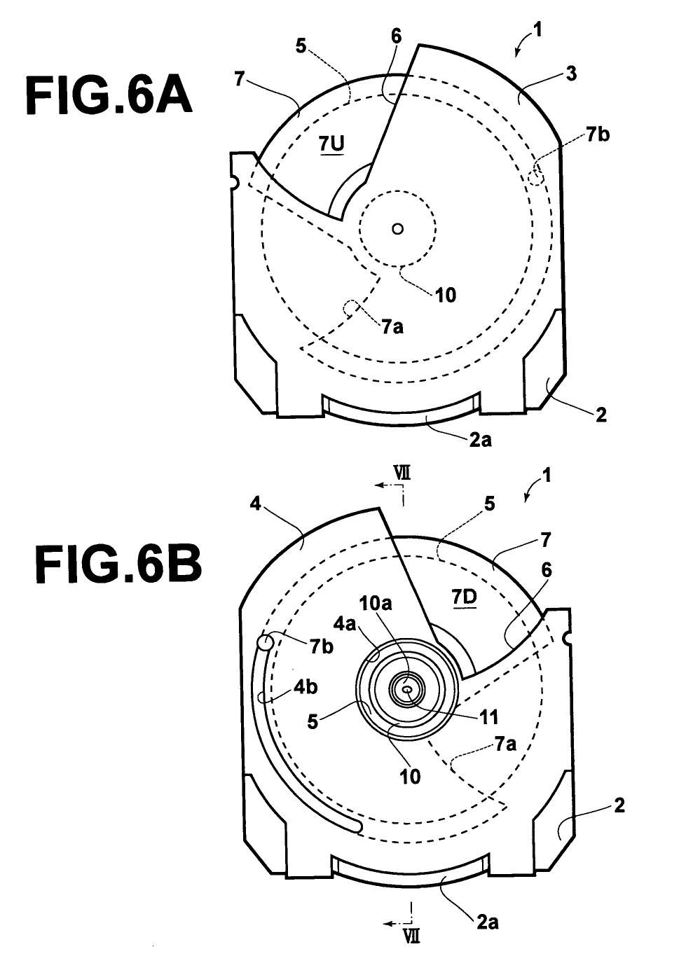

In addition, regarding the slits S, as shown in FIG. 5A, the number of slits is not limited, as long as at least three slits S are formed at substantially equal angular intervals. The smaller the number of slits S, the easier the upper shutter member 7U is to process. However, a small number of slits S causes a problem that the region A becomes difficult to deform during press fitting of the cylinder 3a. If the number of slits S is large, the upper shutter member 7U becomes difficult to process. However, in this case, the region A becomes easy to deform during press fitting of the cylinder 3a.

Further, the guide aperture H is not particularly necessary, and as shown in FIG. 5B, the guide aperture H may be omitted. However, by forming the guide aperture H, the assembly precision is improved. In addition, the contact area of the edges E with respect to the outer peripheral surface of the cylinder 3a is increased, thereby realizing a stable axial support structure.

What is claimed is:

1. A method of mounting a first planar object to a cylinder perpendicularly erected on a second planar object so that the two planar objects are relatively rotatable with respect to each other while maintaining a substantially parallel relationship, comprising the steps of:
forming at least three slits, which extend radially from the center of relative rotation at substantially equal angular intervals, in the first planar object;
making the first and second planar objects approach each other in a manner that the center of relative rotation of the first planar object moves along the axis of the cylinder of the second planar object, while maintaining a substantially parallel relationship therebetween;
press fitting the cylinder into the region of the first planar object having the slits formed therein, causing the region to spread, and thereby rotatably fitting the edges of the region about the outer peripheral surface of the cylinder.

2. The method as defined in claim 1, wherein
the second planar object is a thin metal plate; and
the cylinder is formed by a burring process administered on the second planar object.

3. The method as defined in claim 1, further comprising the step of:
forming a groove, for the edges of the region to engage, in the outer peripheral surface of the cylinder, surrounding outer peripheral surface of the cylinder.

4. The method as defined in claim 2, further comprising the step of:
forming a groove, for the edges of the region to engage, in the outer peripheral surface of the cylinder, surrounding the outer peripheral surface of the cylinder.

5. The method as defined in claim 1, further comprising the steps of:
forming a guide aperture, which has a smaller diameter than the outer diameter of the cylinder and which has as its center the center of relative rotation, in the first planar object; and
forming the slits to extend outwardly from the outer edge of the guide aperture.

6. The method as defined in claim 5, wherein
the second planar object is a thin metal plate; and
the cylinder is formed by a burring process administered on the second planar object.

7. The method as defined in claim 5, further comprising the step of:
forming a groove, for the edges of the region to engage, in the outer peripheral surface of the cylinder, surrounding the outer peripheral surface of the cylinder.

8. The method as defined in claim 6, further comprising the step of:
forming a groove, for the edges of the region to engage, in the outer peripheral surface of the cylinder, surrounding the outer peripheral surface of the cylinder.

9. A disk cartridge comprising:
a flat housing formed by a metal shell;
a disk, which serves as a recording medium, rotatably housed within the housing;
an opening, for allowing a recording/reproducing head provided in a drive apparatus to access the surface of the disk, provided in the housing; and
a rotary shutter, for opening and closing the opening, axially supported to be rotatable by a cylinder, which serves as a shaft, formed on the metal shell; wherein
a guide aperture, which has a smaller diameter than the outer diameter of the cylinder and which has as its center the center of relative rotation of the rotary shutter, in the rotary shutter;
at least three outwardly extending slits are formed at substantially equal angular intervals in the outer edge of the guide aperture; and
the cylinder is press fit into the region which includes the slits so that the rotary shutter is axially supported to be rotatable by the cylinder by the edges of the region elastically contacting the outer peripheral surface of the cylinder.

10. A disk cartridge as defined in claim 9, wherein:
the cylinder is formed by a burring process administered on the metal shell.

11. A disk cartridge as defined in claim 9, wherein
a groove, for the edges of the region to engage, is formed in the outer peripheral surface of the cylinder, surrounding the outer peripheral surface of the cylinder.
